(19) United States
(12) Patent Application Publication
(10) Pub. No.: US 2024/0337869 A1
(43) Pub. Date: Oct. 10, 2024

(54) SELECTIVE WINDOW DARKENING SYSTEM

(71) Applicants: DENSO International America, Inc., Southfield, MI (US); DENSO CORPORATION, Kariya (JP)

(72) Inventors: Ronald KOSLAKIEWICZ, Livonia, MI (US); Mark ROTHENBERG, Farmington Hills, MI (US); Levi PARKINSON, West Bloomfield, MI (US); Mark J. KASTNER, Livonia, MI (US)

(21) Appl. No.: 18/613,626

(22) Filed: Mar. 22, 2024

Related U.S. Application Data
(60) Provisional application No. 63/494,007, filed on Apr. 4, 2023.

(51) Int. Cl. G02F 1/01

(52) U.S. Cl. CPC G02F 1/0126

(57) ABSTRACT

A system for reducing glare in a vehicle includes a windshield treated with a coating, an external light sensor configured to detect a position of a light source external to a vehicle, an eye sensor configured to detect a location of an eye of an operator of the vehicle. The system also includes an emitter configured to excite a location of the coating on the windshield from a first state to a second state that is more opaque than the first state. The system further includes a processor programmed to determine the location of the coating for exciting based on the detected position of the light source and detected position of the eye, and to control the emitter to selectively excite the coating at the location from the first state to the second state.

### CROSS-REFERENCE TO RELATED APPLICATION

The present disclosure claims the benefit of Provisional Patent Application No. 63/494,007, filed on Apr. 4, 2023 and entitled “SELECTIVE WINDOW DARKENING TECHNOLOGY”, the contents of which are incorporated by reference in its entirety.

### TECHNICAL FIELD

The present disclosure relates to systems and methods for darkening a portion of a vehicle windshield. In embodiments, the present disclosure relates to determining where to darken the windshield to prevent, or reduce external luminance from reaching an eye of an operator by using a point controlled emitter to excite a coating on the windshield.

### BACKGROUND

This section provides background information related to the present disclosure which is not necessarily prior art.

Reducing glare or external light from reaching the eyes of a vehicle operator can improve the operator's visibility, passengers, and other persons. Current solutions for reducing glare include manually operated sun visors or sunglasses. These solutions are not sufficient to reduce glare from all angles or under certain conditions such as at night. For example, the operator cannot safely wear sunglasses at night but without protection the operator can be blinded by the headlights of an oncoming vehicle. Another example is the lack of adjustability for devices like sunglasses in situations where the amount of glare varies.

### SUMMARY OF THE INVENTION

Described herein is an embodiment of a system for reducing the amount of light or glare from reaching an operator. The system includes a windshield treated with a coating, an external light sensor configured to detect a position of a light source external to a vehicle and an eye sensor configured to detect a location of an eye of an operator of the vehicle. The system also includes an emitter housed within the vehicle and configured to excite a location of the coating on the windshield from a first state to a second state, wherein the second state is more opaque than the first state and reduces a passage of light from the at least one light source to the at least one eye of the operator. The system further includes a processor programmed to determine the location of the coating for exciting based on the detected position of the light source and detected position of the eye, and to control the emitter to selectively excite the coating at the location from the first state to the second state.

Another embodiment of the system includes a windshield treated with an ultraviolet-active coating, an external light source configured to detect a location of a light source external to a vehicle, and an image sensor configured to generate images of an operator of the vehicle. The system also includes an emitter movably housed within the vehicle and configured to excite a location of the coating from a first state to a second state, wherein the second state is more opaque than the first state. The system further includes a processor programmed to process the images generated by the image sensor to determine a location of eyes of the operator of the vehicle, the location of the coating for exciting based on the determined location of the eyes of the operator and the detected location of a light source external to a vehicle, and control the emitter to excite the location of the coating from the first state to the second state.

In yet another embodiment a method for reducing glare within a vehicle includes detecting a position of a light source external to a vehicle; detecting a location of an eye of an operator of the vehicle; determining a portion of a windshield treated with a coating to darken in response to the position of the light source and the location of the eye, wherein the portion intersects a path between the location of the eye and the position of the light source; and controlling an emitter housed within the vehicle to selectively darken the portion of the windshield by exciting the coating at the portion of the windshield.

### BRIEF DESCRIPTION OF THE DRAWINGS

In the following description, details are set forth to provide an understanding of the present disclosure. In some instances, certain systems, structures and techniques have not been described or shown in detail in order not to obscure the disclosure.

FIG. 1 is a block diagram according to an embodiment of the present invention;

FIG. 2 shows a side view of an operator seated in a vehicle with a coating on a windshield being excited from a first state to a second state according to the embodiment shown in FIG. 1;

FIG. 3 is a flowchart illustrating a method for darkening a windshield according to the embodiment shown in FIG. 1;

FIGS. 4A and 4B are a side view of the operator seated in the vehicle of FIG. 2 showing the coating being excited at different locations on the windshield;

FIG. 5 is a flowchart illustrating a method for darkening a windshield according to the embodiment shown in FIG. 3;

FIG. 6. is a flowchart illustrating a method for darkening a windshield according to an embodiment of the present invention; and

FIG. 7 is perspective view of an interior of a vehicle with a coating on a windshield being excited from a first state to a second state according to the embodiment shown in FIG. 1.

### DETAILED DESCRIPTION OF THE ENABLING EMBODIMENTS

Embodiments of the present disclosure are described herein. It is to be understood, however, that the disclosed embodiments are merely examples and other embodiments can take various and alternative forms. The figures are not necessarily to scale; some features could be exaggerated or minimized to show details of particular components. Therefore, specific structural and functional details disclosed herein are not to be interpreted as limiting, but merely as a representative bases for teaching one skilled in the art to variously employ the embodiments. As those of ordinary skill in the art will understand, various features illustrated and described with reference to any one of the figures can be combined with features illustrated in one or more other figures to produce embodiments that are not explicitly illustrated or described. The combinations of features illustrated provide representative embodiments for typical application. Various combinations and modifications of the features consistent with the teachings of this disclosure, however, could be desired for particular applications or implementations.

“A”, “an”, and “the” as used herein refers to both singular and plural referents unless the context clearly dictates otherwise. By way of example, “a processor” programmed to perform various functions refers to one processor programmed to perform each and every function, or more than one processor collectively programmed to perform each of the various functions.

Described herein are systems and methods for reducing the effects of light sources external to a driver using a point controlled emitter. The systems and methods provide several benefits and advantages such as reducing external luminance or glare, which can impede a driver's visibility, by adjusting the opacity of a windshield between the driver's eyes and the external light source without any action required by the driver. The system and methods provide further benefits and advantages such as the ability to alter the location where the opacity of the windshield is being adjusted based on changes in the position of the external light source or the position of the driver's eyes. The systems and methods also provide an ability to control the magnitude of external light entering the vehicle based on the intensity of the external light or input from the driver.

An exemplary system includes an emitter and window or windshield treated with a coating that can change the opacity of the window when excited by the emitter. The system also includes an eye sensor for detecting the current location of the driver's eye or the direction in which the driver is facing and an external light sensor for detecting the position of the external light source. The system further includes a processor programmed to determine the location on the windshield for the emitter to excite the coating based on the eye position of the driver and the position of the external light source, and to control the emitter to selectively excite the coating at the location on the windshield.

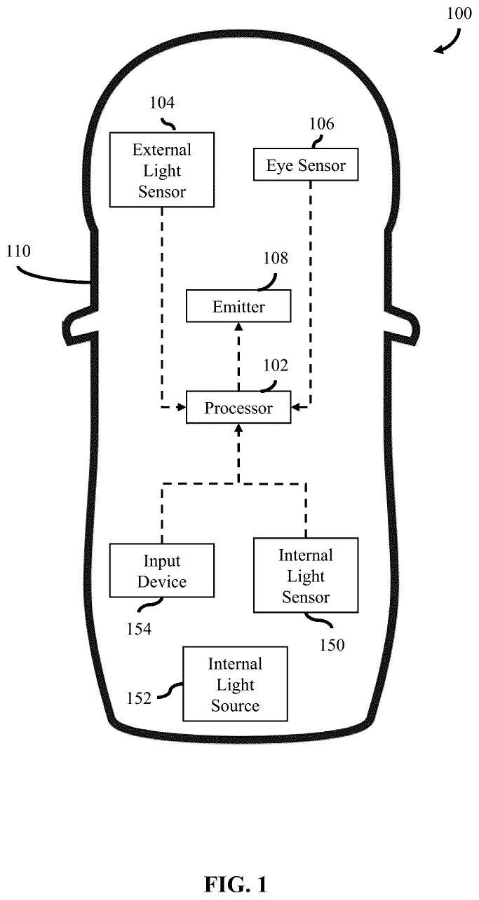

Referring to FIG. 1, a first exemplary embodiment a system 100 for reducing the amount of light or glare from reaching an operator. The system 100 includes a processor 102, an external light sensor 104, an eye sensor 106, and an emitter 108. The processor 102, external light sensor 104, eye sensor 106, and emitter 108 may be housed within a vehicle 110 (e.g., a car, a truck, a train, a plane, or the like) having a windshield 112. In other embodiments, the processor 102, external light sensor 104, eye sensor 106, and emitter 108 may be housed within a building having a window, wherein the window is treated with the coating described herein. An operator 114 may be located within the vehicle 110. The operator 114 may be a human with an eye 116. Alternatively, the operator 114 may be an autonomous driving system or the like that is configured or programed to operate the vehicle 110; in such an embodiment, an optical sensor can be provided instead of an eye 116, and such optical sensor may include a camera, electronic light sensor, or the like that can be affected by the light.

The processor 102 may receive data from components of the system 100, make determinations based on the received data, and may control the operation of the components based on the determinations and received data. For example, the processor 102 may receive data, input, or a signal from the external light sensor 104, and the eye sensor 106. The processor 102 may then process this data and correspondingly control the emitter 108, directing it towards a selected location or point on the windshield 112.

In certain embodiments, the processor 102 includes processor hardware (shared, dedicated, or group) that executes code and memory hardware (shared, dedicated, or group) that stores code executed by the processor hardware. The code is configured to provide the features of the methods and systems described herein. To carry out the control commands provided herein, a controller may include the processor 102, memory, and non-volatile storage. The processor may include one or more devices selected from microprocessors, micro-controllers, digital signal processors, microcomputers, central processing units, field programmable gate arrays, programmable logic devices, state machines, logic circuits, analog circuits, digital circuits, or any other devices that manipulate signals (analog or digital) based on computer-executable instructions residing in memory. The memory may include a single memory device or a plurality of memory devices including, but not limited to, random access memory (“RAM”), volatile memory, non-volatile memory, static random-access memory (“SRAM”), dynamic random-access memory (“DRAM”), flash memory, cache memory, or any other device capable of storing information. The non-volatile storage may include one or more persistent data storage devices such as a hard drive, optical drive, tape drive, non-volatile solid-state device, or any other device capable of persistently storing information. The processor 102 may be configured to read into memory and execute computer-executable instructions embodying one or more software programs residing in the non-volatile storage. Programs residing in the non-volatile storage may include or be part of an operating system or an application, and may be compiled or interpreted from computer programs created using a variety of programming languages and/or technologies, including, without limitation, and either alone or in combination, Java, C, C++, C #, Objective C, Fortran, Pascal, Java Script, Python, Perl, and PL/SQL. The computer-executable instructions of the programs may be configured, upon execution by the processor 102, to output control signals to control the emitter 108 to selectively excite a coating on the windshield 112 at a location to a more opaque state, for example.

Implementations of the subject matter and the operations described in this specification can be implemented in digital electronic circuitry, or in computer software embodied on a tangible medium, firmware, or hardware, including the structures disclosed in this specification and their structural equivalents, or in combinations of one or more of them. Implementations of the subject matter described in this specification can be implemented as one or more computer programs embodied on a tangible medium, e.g., one or more modules of computer program instructions, encoded on one or more computer storage media for execution by, or to control the operation of, a data processing apparatus. A computer storage medium can be, or be included in, a computer-readable storage device, a computer-readable storage substrate, a random or serial access memory array or device, or a combination of one or more of them. The computer storage medium can also be, or be included in, one or more separate components or media (e.g., multiple CDs, disks, or other storage devices). The computer storage medium may be tangible and non-transitory.

A computer program (also known as a program, software, software application, script, or code) can be written in any form of programming language, including compiled languages, interpreted languages, declarative languages, and procedural languages, and the computer program can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, libraries, sub programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatus can also be implemented as, special purpose logic circuitry, e.g., a field programmable gate array (“FPGA”) or an application specific integrated circuit (“ASIC”).

The external light sensor 104 is configured to detect a position of an external light source 118 that is external to the vehicle 110 or has a light path that originates outside of the vehicle 110. For example, the external light source 118 may be the sun, a traffic light, vehicle lights (e.g., high beams), or the like. In certain embodiments, the external light sensor 104 is configured to detect a magnitude of an external luminance of the external light source 118 that is entering the interior of the vehicle 110 through the windshield 112. The external light sensor 104 may include any sensor and/or associated processing unit that is capable of detecting the position of the external light source 118, the light path of the external light source 118, the magnitude of an external luminance of the external light source 118, or the like, or a combination or sub-combination thereof. The external light sensor 104 may be movably housed within the vehicle 110 and may be placed on a front dashboard, rear dashboard, on the interior roof, or the like. The external light sensor 104 may also be mounted on the exterior of the vehicle 110.

The external light sensor 104 may be configured to detect the position of multiple external light sources 118, light paths of multiple external light sources 118, and/or magnitudes of the external luminance of the individual external light sources 118. Optionally, a plurality of external light sensors 104 may be used, individually or in cooperation with each other or a combination thereof, to detect the position of multiple external light sources 118, light paths of multiple external light sources 118, and/or magnitudes of the external luminance of the individual external light sources 118.

The eye sensor 106 is configured to detect a location of an eye 116 of the operator 114 or a passenger. The eye sensor 106 may include any sensor capable of detecting data corresponding to a location of the eye 116. For example, the eye sensor 106 may include a camera facing the operator that generates images or image data of the operator 114, the eye 116, or an area of the interior of the vehicle 110 in which the operator's 114 eye 116 or head is likely to be positioned, and transmits the images to the processor 102. The processor 102 then processes the images or image data generated by eye sensor 106 to determine the location of the eye 116. In other embodiments, the eye sensor 106 may track or acquire information on the position of the eye 116 using an infrared device or the like. The eye sensor 106 may be any sensor capable of providing real-time tracking of the eye 116. In certain embodiments, the eye sensor 106 may include more than one camera or other type of eye sensor to generate image data. For example, one camera may be mounted in front of the operator 114 and another camera may be mounted behind or to the side of the operator 114 such that image data of the operator's 114 forward facing orientation may be obtained from a multitude of angles, enabling increased accuracy, prediction, and monitoring of the operator 114 or the eye 116.

The eye sensor 106 and associated processing hardware may also include, or be part of, a facial recognition system configured to determine the presence and location of the eyes 116 using facial recognition. Such a system can rely on deep learning and neural networks, such as Convolutional Neural Networks (CNNs). For example, models such as VGG, ResNet, EfficientNet and transformer-based models (e.g., ViT) can be executed by the processors and memory disclosed herein. Additionally, Techniques like Haar cascades, Local Binary Patterns (LBP), and Histogram of Oriented Gradients (HOG) can be used to identify facial features, which includes the eyes 116. These sort of facial recognition systems can be used for driver awareness, enabling the vehicle 110 to alert the operator 114 of the vehicle 110 if he or she appears to be drowsy or distracted during driving. Such data generated can be relied upon in this disclosure for determining the presence and location of the operator's 114 eyes 116 for controlling the emitter 108.

The windshield 112 may be composed of materials such as glass, acrylic, laminate, vinyl, or the like, and the materials may be subject to various treatment processes. The windshield 112 may also include a coating applied to the interior or exterior of the windshield 112 that can be excited by the emitter 108 from a first state 122 to a second state 124 that is more opaque than the first state 122. For example, the coating may be a photochromatic substance or chromotropic film that darkens in response to certain wavelengths or intensities of light, such wavelengths or intensities being emitted from the emitter 108. The second state 124 reduces the magnitude of the external luminance of the external light source 118 entering the vehicle 110 and reaching the eye 116, relative to the first state 122 (e.g., the first state 122 is transparent and the second state 124 is non-transparent, or the first state 122 is non-transparent and the second state 124 is more opaque than the first state 122, or the like). The coating can also return to an original state or the first state 122 after a period of time in which the emitter has not excited the coating. The original state is a state prior to any excitement of the coating by the emitter, and in some situations may be the same as the first state 122. In certain embodiments, the coating may be an ultraviolet active coating or the like. In some embodiments, the degree by which the windshield 112 transitions from the first state 122 to the second state 124, or transitions from the second state 124 to the first state 122 or the original state, or the like, is affected by the coating's properties, location, thickness, or the like or a combination or sub-combination thereof. Optionally, different types of coatings or thicknesses of the coating may be applied the windshield in order to affect the degree by which the windshield 112 transitions from the first state 122 to the second state 124, or transitions from the second state 124 to the first state 122 or the original state, or the like.

In other embodiments, the degree by which the windshield 112 transitions from the first state 122 to the second state 124 is controlled by the emitter 108. For example, the emitter 108 can emit a photon at a desired wavelength, intensity, or pattern, or the like, to excite the coating at a desired rate or area. The emitter 108 may emit infrared light or radiation. The emitter 108 is a point controlled device (i.e., it is controlled to selectively target a desired location) and may be a photon gun, phaser, or the like. The emitter 108 may be movably housed within the vehicle 110 or outside of the vehicle 110 and may be rotatable in a multitude of directions such that the emitter 108 can be directed at various locations on the windshield 112 or other locations within the interior of the vehicle 110. In certain embodiments, a plurality of emitters 108 may be used individually, or in conjunction with each other, to excite the coating at the same or different locations on the windshield 112.

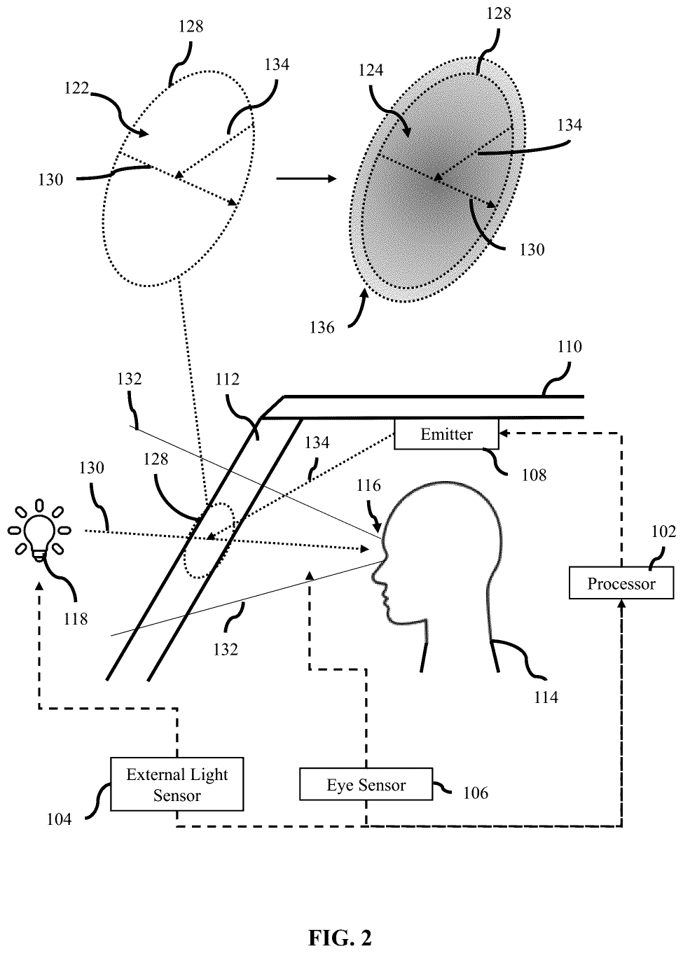

Referring to FIG. 2, the processor 102 is programmed to receive data from the external light sensor 104 and the eye sensor 106 and to determine a first location 128 on the windshield 112 for the emitter 108 to excite the coating at the first location 128. Generally, the first location 128 is an area in which a first path of light 130 from the external light source 118 is directed towards or interacts with a line of sight 132 of the operator 114. In some embodiments, the first location 128 is an area in which the first path of light 130 is directed towards or interacts with a line of sight of a passenger. As previously mentioned, the first path of light 130 from the external light source 118 can impair the operator's vision. The external light source 118 can also increase strain upon the eye 116, causing future problems for the operator 114, and/or reduce the ability of the operator 114 to perform a task (e.g., driving, navigating, locating an object, etc.). Darkening or increasing the opacity of the windshield 112 from a first state 122 to a second state 124 can alleviate these issues. Thus, the processor 102 uses information from the external light sensor 104 and the eye sensor 106 to determine the first location 128 and controls the emitter 108 to selectively excite the coating at the first location 128 from the first state 122 to the second state 124. The emitter 108 selectively excites the coating at the first location 128 by emitting photons along an emission path 134.

The processor 102 controls the emitter 108 to excite the coating from the first state 122 to the second state 124 based on data from the external light sensor 104 and the eye sensor 106. For example, the processor 102 may be programmed to determine a desired opacity of the second state 124 based on the position of the external light source 118, the light path of the external light source 118, the magnitude of an external luminance of the external light source 118, a luminous intensity of the external light source 118, or the like, or a combination or sub-combination thereof. The desired opacity of the second state 124 may be established by an input from the operator 114 or by an operating logic of the processor 102 or another control device. Similarly, an input from the operator 114 or an operating logic may affect the duration of the transition from the first state 122 to the second state 124 by programing the processor 102 to control the wavelength, intensity, or pattern, or the like, of the photons emitted by the emitter 108.

In some embodiments, there may be a bleed out area 136 adjacent to the first location 128 where the coating is excited to a second state 124 that is less opaque than the second state 124 of the first location 128. In other words, the emitter 108 may emit photons that incidentally excite the coating at the bleed out area 136 such that the coating is not excited to same degree or state as at the first location 128. The establishment of the bleed out area 136 may be affected by the design of the coating or the emitter 108, or by the processor 102 controlling the emitter 108, or the like, or a combination or sub-combination thereof.

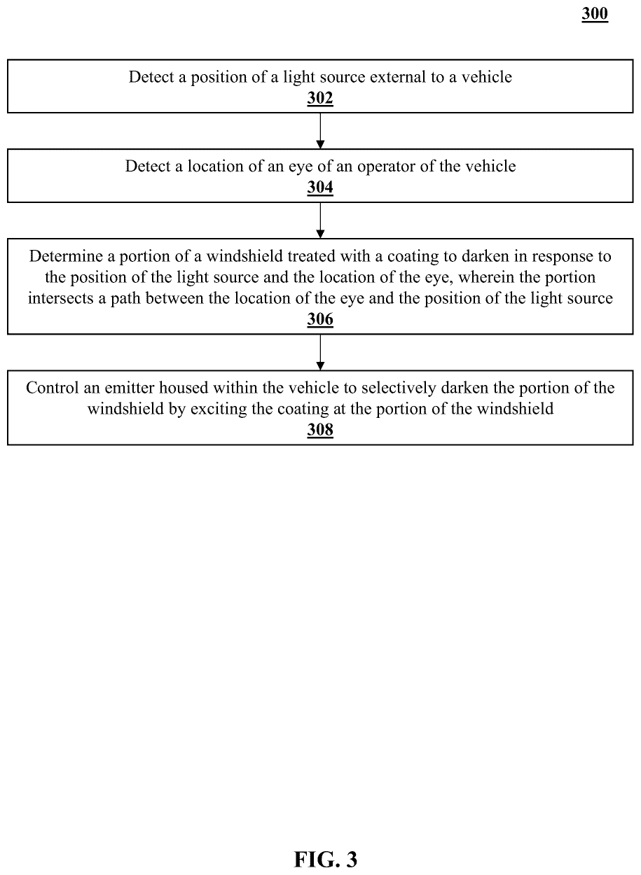

FIG. 3 illustrates a method 300 of darkening a portion of a windshield, according to one embodiment. The method 300 can be performed by the processor 102 and associated memory. At 302, the external light sensor 104 (and associated processor) detects a position of the light source external to the vehicle 110. At 304, the eye sensor 106 (and associated processor) detects a location of an eye 116 of an operator 114. At 306, the processor 102 determine a portion of the windshield 112 to darken based on the position of the light source and the location of the eye 116, as determined by the external light sensor 104 and eye sensor 106, respectively. This portion of the windshield is one that intersects a path between the location of the eye 116 and the position of the light source. At 308, the processor 102 controls the emitter 108 to selectively darken the portion of the windshield 112 by exciting the coating at the determined portion of the windshield 112.

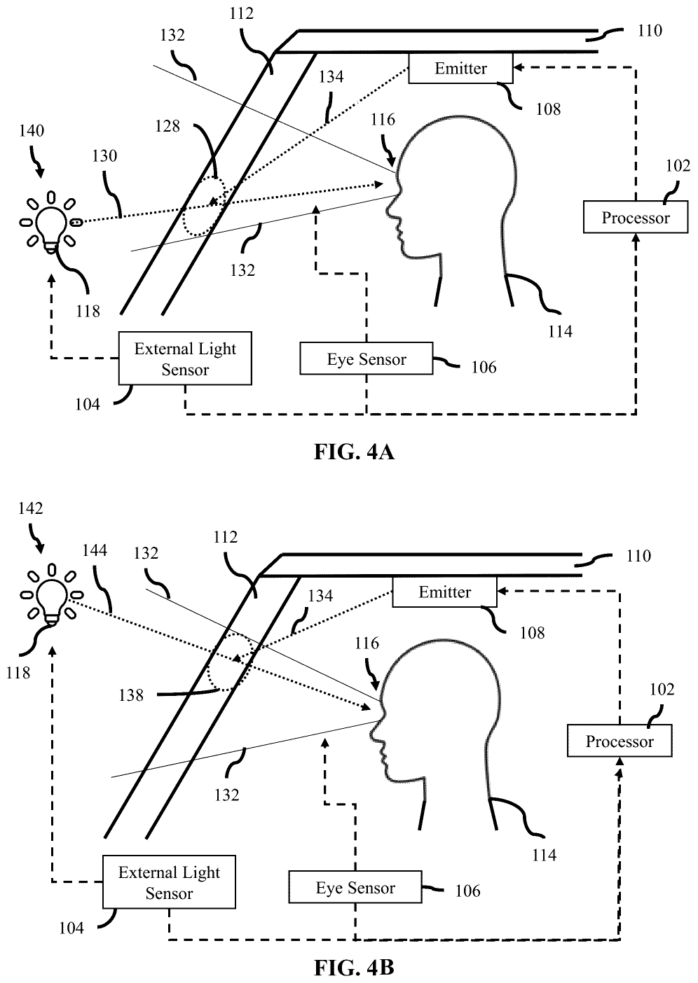

Referring to FIGS. 4A and 4B, if the external light sensor 104 detects that the position of the external light source 118, the first path of light 130, or the magnitude of an external luminance of the external light source 118 has changed, then the processor 102 may deactivate the emitter 108 or control the emitter 108 to excite the coating from the second state 124 to the first state 122, or a state between the second and first states 124, 122. Likewise, if the eye sensor 106 detects that the line of sight 132 has changed for a period of time (e.g., the operator 114 faces a new direction, etc.) then the processor 102 may deactivate the emitter 108 or control the emitter 108 to excite the coating from the second state 124 to the first state 122, or a state between the second and first states 124, 122. The period of time that the line of sight 132 has changed may be based on an input by the operator 114 or an algorithm.

If the external light sensor 104 detects that the position or path of light of the external light source 118 has changed, or the eye sensor 106 detects that the line of sight 132 has changed (e.g., the location of the external light source 118 moves relative to the vehicle 110 or windshield 112, the operator 114 faces a new direction, and/or the eye 116 is directed to a new direction etc.), then the processor 102 can determine a second location 138 on the windshield 112 and can control the emitter to excite the coating at the second location 138. For example, the position of the external light source 118 may change from a first position 140 to a second position 142 having a second path of light 144. In another example, the external light source 118 may have a plurality of paths of light where either the first path of light 130 or second path of light 144 may move or cease to be directed at the operator 114 due to alteration in an angle of reflection (such as when the vehicle 110 may move past a reflective surface and there is no longer an angle of reflection directing the second path of light 144 at the operator 114). In yet a further example, the eye 116 may be directed from a first direction to a second direction such as when the operator 114 shifts the focus of the eye 116 from a driver's side to a passenger side of the vehicle 110.

In certain embodiments, the processor 102 deactivates the emitter 108 and then re-directs the emitter 108 towards the second location 138. In other embodiments, the processor 102 re-directs the emitter 108 towards the second location 138 without deactivating the emitter 108 (e.g., the emitter 108 continuously excites the coating from the first location 128 to the second location 138, tracing a path across the windshield 112).

In embodiments with a plurality of emitters 108, the processor 102 may deactivate a first emitter 108a, direct a second emitter 108b towards the second location 138, and activate the second emitter 108b to excite the coating at the second location 138. The first emitter 108a may be deactivated before or after the activation of the second emitter 108b, or after a period of time in which the second emitter 108b has been activated (e.g., a period of time in which the coating at the second location 138 transitions from the first state 122 to the second state 124).

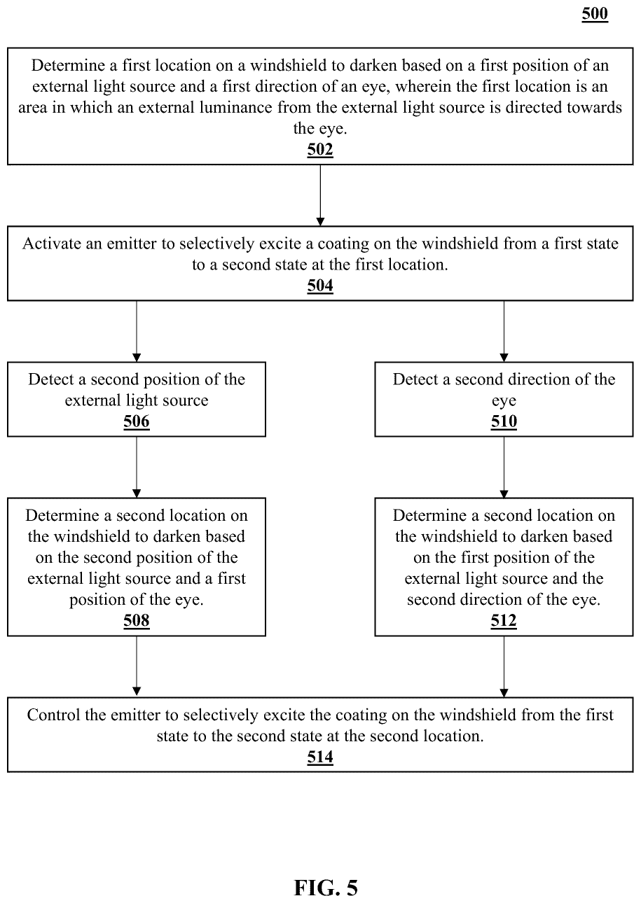

FIG. 5 illustrates a method 500 of darkening two or more locations on the windshield 112, according to one embodiment. The method 500 can be performed by the processor 102 and associated memory. At 502, the processor 102 determines the first location 128 on the windshield 112 to darken based on the first position 140 of the external light source 118 and a first position of the eye 116. This first location 128 is an area in which the external luminance from the external light source 118 is directed towards the eye 116. At 504, the emitter 108 is activated to selectively excite the coating on the windshield 112 from the first state 122 to the second state 124 at the first location 128. Method 500 may then proceed by either step 506 or 510. At 506, the external light sensor 104 (and associated processor) detects that the external light source has moved to the second position 142. At 508, the processor 102 determines the second location 138 on the windshield 112 to excite from the first state 122 to the second state 124 based on the second position 142 of the external light source 118 and the first direction of the eye 116. At 510, the eye sensor 106 (and associate processor) detects that the eye 116 is directed to a second direction. At 512, the processor 102 determines the second location 138 on the windshield 112 to darken based on the first position 140 of the external light source 118 and the second direction of the eye 116. After either 508 and/or 512, method 500 proceeds with step 514 where the processor 102 controls the emitter 108 to selectively excite the coating on the windshield 112 from the first state 122 to the second state 124 at the second location 138.

Referring to FIG. 1, in a second embodiment, the system 100 further comprises an internal light sensor 150 configured to detect a magnitude of an internal luminance within the interior of the vehicle 110. The internal luminance may be the background or ambient light intensity within the vehicle 110. The internal luminance may be a result of an internal light source 152 that originates from within the interior of the vehicle 110 or the external light source 118 (e.g., light from another vehicle's headlights entering the vehicle 110 through a rear windshield, sunlight being reflected into the vehicle 110, or the like). The internal light source 152 may include light emitted from interior illumination systems such as instrument lights, dome lights, mirror lights, reading lamps, storage lights, or the like, or from other devices such as cell phones, laptops, tablets, flashlights, or the like. The internal light sensor 150 may also be configured to detect a position of the internal light source 152. The internal light sensor 150 may include any sensor or processing unit that is capable of detecting the magnitude of the internal luminance, the position of the internal light source 152, or the like, or a combination or sub-combination thereof. The internal light sensor 150 may also be configured to detect the position of multiple internal light sources 152 and/or the magnitudes of the internal luminance of the individual internal light sources 152. Optionally, a plurality of internal light sensors 150 may be used individually or in cooperation with each other or a combination thereof, to detect the position of the multiple internal light sources 152, and/or the magnitude of the internal luminance. The internal light sensor 150 may be movably housed within the interior of the vehicle 110. In certain embodiments, the external light sensor 104 or eye sensor 106 may be configured to act as the internal light sensor 150.

The processor 102 is programmed to receive data from the internal light sensor 150 and to activate the emitter 108 in response to the magnitude of the external luminance being greater than a threshold relative to the internal luminance. For example, at nighttime the internal light sensor 150 may detect a low magnitude of the internal luminance and the external light sensor 104 may detect a larger magnitude (relative to the internal luminance) for the external luminance from a headlight of another vehicle such that processor 102 activates the emitter 108 to excite the coating at the first location 128. The processor 102 controls the intensity of the emitter 108 based on the degree by which the magnitude of the external luminance exceeds the threshold. The threshold may be determined by input from the operator 114 or by an operating logic.

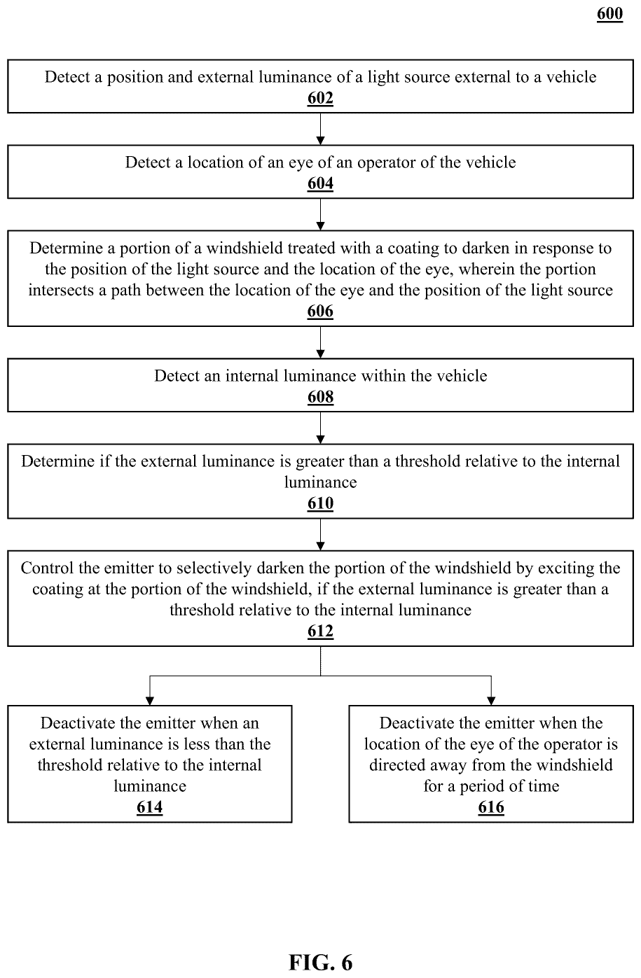

FIG. 6 illustrates a method 600 for darkening a portion of the windshield 112, according to one embodiment. The method 600 can be performed by the processor 102 and associated memory. At 602, the external light sensor 104 (and associated processor) detects a position of the light source external to the vehicle 110 and an external luminance of the light source. At 604, the eye sensor 106 (and associated processor) detects a location of an eye 116 of an operator 114. At 606, the processor 102 determine a portion of the windshield 112 to darken based on the position of the light source and the location of the eye 116, as determined by the external light sensor 104 and eye sensor 106, respectively. This portion of the windshield is one that intersects a path between the location of the eye 116 and the position of the light source. At 608, the internal light sensor 150 detects the internal luminance within the vehicle 110. At 610, the processor 102 determines if the external luminance is greater than a threshold relative to the internal luminance. At 612, if the external luminance is greater than a threshold relative to the internal luminance, the processor 102 controls the emitter 108 to selectively darken the portion of the windshield 112 by exciting the coating at the determined portion of the windshield 112. At 614, the processor 102 deactivates the emitter 108 when the external luminance is less than the threshold relative to the internal luminance. Alternatively, at 616, the processor 102 deactivates the emitter 108 when the location of the eye 116 is directed away from the windshield 112 for a period of time.

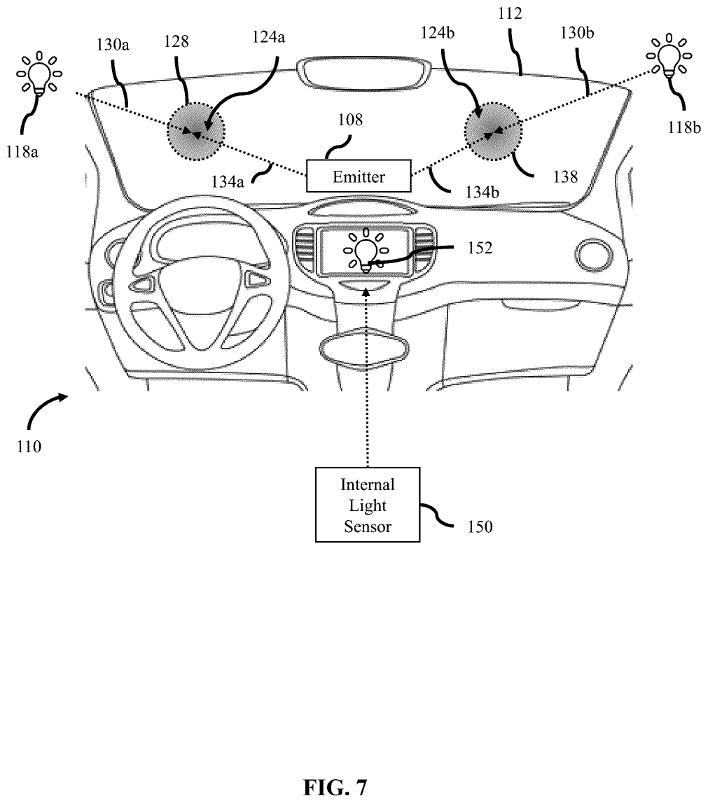

Referring to FIG. 7, in one embodiment of the system 100 the emitter 108 is configured to simultaneously excite the coating at both the first location 128 and the second location 138. For example, the emitter 108 may include a plurality of outlets to direct emission paths 134a, 134b at the first and second locations 128, 138. In other embodiments, the plurality of emitters 108 may be contemporaneously controlled by the processor 102 to excite the coating at both the first and second locations 128, 138. The first and second state 122, 124 of the first and second locations 128, 138 may be similar or different depending on the determination of the processor 102. For example, an external light source 118a may have a different external luminance than an external light source 118b such that the processor 102 determines that the coating at the first location 128 need only be excited to a second state 124a that is more/less opaque than the second state 124b of the coating at the second location 138. The external light sources 118a, 118b may have a first path of light 130a, 130b, respectively.

Referring to FIG. 1, in a third embodiment, the system 100 further comprises an input device 154 that is configured to receive input directly or remotely and to adjust how the processor 102 controls the emitter 108 (e.g., altering the threshold when the emitter 108 is activated based on the external luminance and the internal luminance, the period of time the line of sight has changed, etc.).

While exemplary embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further embodiments of the invention that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. These attributes can include, but are not limited to cost, strength, durability, life cycle cost, marketability, appearance, packaging, size, serviceability, weight, manufacturability, ease of assembly, etc. As such, to the extent any embodiments are described as less desirable than other embodiments or prior art implementations with respect to one or more characteristics, these embodiments are not outside the scope of the disclosure and can be desirable for particular applications.

What is claimed is:

1. A system for selectively darkening a windshield treated with a coating, the system comprising:
an external light sensor configured to detect a position of an external light source external to a vehicle;
an eye sensor configured to detect a location of an eye of an operator of the vehicle;
an emitter housed within the vehicle and configured to excite a location of a coating on a windshield from a first state to a second state, wherein the second state is more opaque than the first state and reduces a passage of light from the external light source to the eye of the operator; and
a processor programmed to determine a first location of the coating for exciting based on the detected position of the external light source and detected location of the eye, and to control the emitter to selectively excite the coating at the first location from the first state to the second state.

2. The system of claim 1 further comprising the windshield treated with the coating and an internal light sensor configured to sense an internal luminance within the vehicle, wherein the external light source is configured to detect a magnitude of an external luminance of the external light source, and wherein the processor is programmed to activate the emitter to excite the first location of the coating in response to the magnitude of the external luminance being greater than a threshold relative to the internal luminance.

3. The system of claim 1 wherein the external light sensor or the eye sensor are configured to sense an internal luminance within the vehicle, and wherein the processor activates the emitter to excite first location of the coating when an external luminance sensed by the external light sensor is greater than a threshold relative to the internal luminance.

4. The system of claim 1 wherein the coating is an ultraviolet active coating.

5. The system of claim 1 wherein the emitter is a phaser and emits photons to excite the coating.

6. The system of claim 1 wherein the processor controls an intensity generated by the emitter based on a magnitude of the external light source as determined by the external light sensor.

7. The system of claim 1 wherein the processor is responsive to a change of position of the external light source relative to the windshield, and wherein the processor controls the emitter to excite a second location of the coating based on the change in position of the external light source.

8. The system of claim 1 wherein the processor is responsive to a change of location of the eye of the operator relative to the windshield, and wherein the processor controls the emitter to excite a second location of the coating based on the change in location of the eye of the operator.

9. The system of claim 1 wherein the processor is programmed to determine a second location of the coating for exciting based on the detected position of the external light source and detected position of the eye, wherein the emitter is configured to contemporaneously excite both the first location of the coating and a second location of the coating, wherein the processor is programmed to control the emitter to contemporaneously excite both the first location of the coating and a second location of the coating.

10. The system of claim 1, wherein the emitter is mounted to the vehicle in a rotatable manner allowing rotation of the emitter, and wherein the processor is programmed to rotate the emitter based upon the detected position of the external light source and detected location of the eye.

11. A method, comprising:
detecting a position of a light source external to a vehicle;
detecting a location of an eye of an operator of the vehicle;
determining a portion of a windshield treated with a coating to darken in response to the position of the light source and the location of the eye, wherein the portion intersects a path between the location of the eye and the position of the light source; and
controlling an emitter housed within the vehicle to selectively darken the portion of the windshield by exciting the coating at the portion of the windshield.

12. The method of claim 11 further comprising:
detecting an internal ambient luminance within the vehicle;
detecting an external luminance from the light source; and
activating the emitter when the external luminance is greater than a threshold relative to the internal ambient luminance.

13. The method of claim 11 further comprising:
deactivating the emitter when an external luminance is less than a threshold relative to an internal ambient luminance.

14. The method of claim 11 further comprising:
deactivating the emitter when the location of the eye of the operator is directed away from the windshield for a period of time.

15. A system for reducing glare within a vehicle, the system comprising:
a windshield treated with an ultraviolet-active coating;
an external light sensor configured to detect a location of a light source external to a vehicle;
an image sensor configured to generate images of an operator of the vehicle;
an emitter movably housed within the vehicle and configured to excite a location of the coating from a first state to a second state, wherein the second state is more opaque than the first state; and
a processor programmed to:
process the images generated by the image sensor to determine a location of eyes of the operator of the vehicle,
determine a first location of the coating for exciting based on the determined location of the eyes of the operator and the detected location of a light source external to a vehicle, and
control the emitter to excite the first location of the coating from the first state to the second state.

16. The system of claim 15 further comprising an internal light sensor configured to sense an internal luminance within the vehicle, wherein the light source is configured to detect a magnitude of an external luminance of the light source external to the vehicle, and wherein the processor is programmed to activate the emitter to excite the first location of the coating in response to the magnitude of the external luminance being greater than a threshold relative to the internal luminance.

17. The system of claim 15 wherein the processor controls an intensity generated by the emitter based on a magnitude of the light source as determined by the external light sensor.

18. The system of claim 15 wherein the processor is responsive to a change of position of the light source relative to the windshield, and wherein the processor controls the emitter to excite a second location of the coating based on the change in position of the light source.

19. The system of claim 15 wherein the processor is responsive to a change of location of the eye of the operator relative to the windshield, and wherein the processor controls the emitter to excite a second location of the coating based on the change in location of the eye of the operator.

20. The system of claim 15 wherein the emitter is configured to contemporaneously excite both the first location and a second location of the coating.
